(19) United States
(12) Patent Application Publication
(10) Pub. No.: US 2009/0265311 A1
(43) Pub. Date: Oct. 22, 2009

(54) Intellectual Property Subscribe And Publish Notification Service

(75) Inventors: Lisa M. Chavez, Tuscon, AZ (US); Rhonda L. Childress, Austin, TX (US); David Bruce Kumhyr, Austin, TX (US); Pamela Ann Nesbitt, Tampa, FL (US); Michael John Spisak, East Northport, NY (US)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/104,203

(22) Filed: Apr. 16, 2008

(51) Int. Cl. G06F 7/10; G06F 17/30

(52) U.S. Cl. 707/3; 707/E17.014

(57) ABSTRACT

Illustrative embodiments provide a computer implemented method, an apparatus in the form of a data processing system, and a computer program product for an intellectual property subscribe and publication notification service. In one illustrative embodiment the computer implemented method comprises obtaining an intellectual property source and creating a list of approved subscribers for the intellectual property source, wherein each subscriber of the list of subscribers indicates elements of interest. The computer implemented method further comprises creating a set of queries comprising the elements of interest associated with the list of approved subscribers and monitoring the intellectual property source for the elements of interest to create identified elements of interest. The computer implemented method then publishing notification of the identified elements of interest to the list of approved subscribers.

### BACKGROUND OF THE INVENTION

1. Field of the Invention

The present invention relates generally to an improved data processing system, and in particular to a computer implemented method, an apparatus, and a computer program product for an intellectual property subscribe and publication notification service.

2. Description of the Related Art

In a software development environment intellectual property professionals may monitor progress of intellectual property in either a proactive or reactive manner. Knowledge of the intellectual property portfolio changes may be acquired, in either case, in a manner that keeps the intellectual property professionals anonymous to the product developers. Changes to the intellectual property assets may be made by contributions of the product developers. The contributions may then later be analyzed and reviewed by the intellectual property professionals to determine specific categories of intellectual property development.

Intellectual property professionals, such as the attorneys and intellectual property portfolio managers, often have special needs for intellectual property driven by confidential or strategic business needs. Broadcasting these needs to the product development community runs counter to the interests of the business or may violate confidentiality policies or needs. Currently these intellectual property needs are usually met rather randomly by perusing categories or by happenstance on hearing of some related work in a particular area of interest. Formal reviews may or may not expose specific instances of intellectual property inclusion in a product under development.

### SUMMARY OF THE INVENTION

Illustrative embodiments provide a computer implemented method, an apparatus in the form of a data processing system and a computer program product for an intellectual property subscribe and publication notification service. In one illustrative embodiment, a computer implemented method comprises obtaining an intellectual property source and creating a list of subscribers for the intellectual property source, wherein each subscriber of the list of subscribers indicates elements of interest. The computer implemented method further comprises creating a set of queries comprising the elements of interest associated with the list of subscribers, and monitoring the intellectual property source for the elements of interest to create identified elements of interest. The computer implemented method thereafter publishing notification of the identified elements of interest to the list of subscribers.

In another illustrative embodiment, a data processing system comprises, a bus, a memory connected to the bus, the memory containing computer executable instructions therein, a communications unit connected to the bus, a persistent storage connected to the bus, and a processor unit connected to the bus, wherein the processor unit executes the computer executable instructions in the memory. Executing the computer executable instructions in the memory causes the data processing system to obtain an intellectual property source, create a list of subscribers for the intellectual property source, wherein each subscriber of the list of subscribers indicates elements of interest, and creates a set of queries comprising the elements of interest associated with the list of subscribers. Executing the computer executable instructions in the memory further causes the data processing system to monitor the intellectual property source for the elements of interest to create identified elements of interest, and publish notification of the identified elements of interest to the list of subscribers.

In another illustrative embodiment a computer program product comprising a computer usable recordable medium having computer executable instructions tangibly embodied thereon, the computer executable instructions comprise computer executable instructions for obtaining an intellectual property source, computer executable instructions for creating a list of subscribers for the intellectual property source, wherein each subscriber of the list of subscribers indicating elements of interest, and computer executable instructions for creating a set of queries comprising the elements of interest associated with the list of subscribers. The computer executable instructions further comprise computer executable instructions for monitoring the intellectual property source for the elements of interest to create identified elements of interest, and computer executable instructions for publishing notification of the identified elements of interest to the list of subscribers.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a high level view of components of a subscription and publication service in accordance with illustrative embodiments;

FIG. 4 is a text representation of an example of search arguments in accordance with illustrative embodiments;

FIG. 5 is a text representation of an example marking of code in accordance with illustrative embodiments; and

FIG. 6 is a flowchart of an example subscription and publication service in accordance with illustrative embodiments.

### DETAILED DESCRIPTION OF THE PREFERRED EMBODIMENT

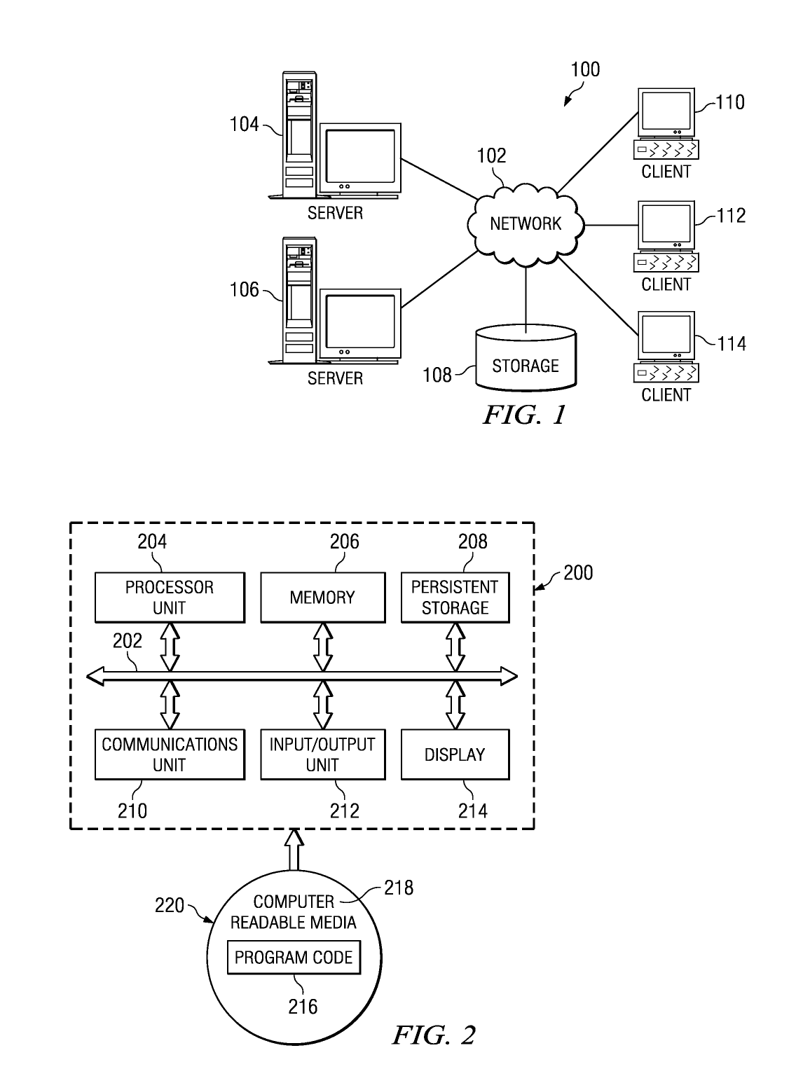

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

For example, using network data processing system 100, an intellectual property professional user on client 110 requests to subscribe to receive notifications, based upon categories of interest, of pending intellectual property source documents containing intellectual property elements maintained on server 106. Typical reviews and approvals ensure only approved subscribers are added to a subscription list. Approval resources, as needed for authentication and permission, may be maintained on another server such as server 104 in the network. The notifications of updates may be generated from the documents located on a server such as server 106 of interest to a user on client 110 by monitoring and reporting services on server 106. The notifications would then be sent through network 102 from server 106 to the approved subscribing client 110.

Based on the received notifications, intellectual property professionals would then be made aware of the intellectual property progress and even intervene, if necessary, to direct the course of the intellectual property elements described in the pending intellectual property source documents. The documents may also include past intellectual property elements that are no longer being developed, but are still of value. Documents are not limited to simple text documents, but may also include product code, image, and sound data in a number of known formats accessible to and referenced by the monitoring service.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202.

Illustrative embodiments provide a capability for intellectual property professionals to subscribe to a subscription and notification service to receive notifications on elements of particular interest. Authorized subscribers are added to a list of approved subscribers. Queries are performed using search criteria including subscriber identified elements of interest against intellectual property sources to produce reports. The reports are then provided as notifications to the respective subscribers. Intellectual property subscribers remain anonymous to the providers of intellectual property source. As a result the subscribers may more effectively manage the intellectual property source.

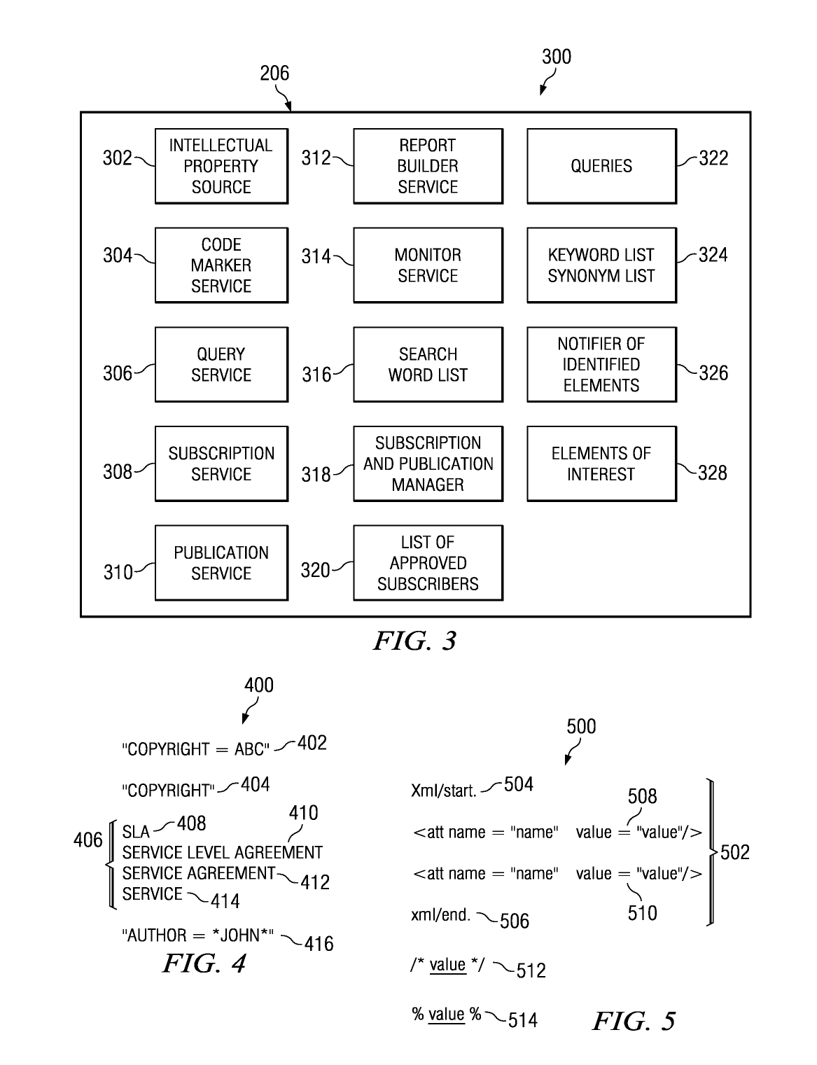

With reference to FIG. 3, a block diagram of a high level view of components of a subscription and publication service in accordance with illustrative embodiments is shown. Intellectual property subscribe and publication notification service 300 is an example process including components of subscription and publication manager 318. Subscription and publication manager 318 comprises a number of additional components or services specific to the management and control of intellectual property subscribe and publication notification service 300. For example, components including intellectual property source 302, code marker service 304, query service 306, subscription service 308, publication service 310, report builder service 312, monitor service 314, and search word list 316, list of approved subscribers 320, set of queries 322, keyword list and synonym list 324, notifier of identified elements 326 and elements of interest 328 are managed by subscription and publication manager 318. Other components as typically required to deliver system support are not shown.

Intellectual property source 302 is typically a set of documents providing the source of intellectual property information within which is contained the elements of interest to the intellectual property professionals. For example, the source may be a database comprising product code or it may be a collection of invention disclosure documents, or other suitable source of gathering information on intellectual property assets for the purposes of query and reporting.

Code marker service 304 provides a capability to mark or tag product code or documentation to include descriptors used to identify intellectual property elements contained within. Tagging information enables searching and retrieval functions to be used more efficiently by the discovering and reporting procedures. Query service 306 provides services to create and manage search selection specifications used to mine the information in the source material of intellectual property source 302.

Subscription service 308 and companion service publication service 310 cooperate to manage those users desiring notification of the intellectual property elements of interest. Subscription service 308 provides a capability to allow users with appropriate permission to request to be notified in the event certain intellectual property elements of interest are found within the source information. The intellectual property professional remains unknown to creators of the intellectual property elements in the source information.

Subscription service 308 may use authentication services of the system or additional services contain within to validate a subscribe request. Users that have been validated are approved and permitted to be added to a list of approved subscribers 320. Approval may be as granular as required to limit requests and associated notifications to specific intellectual property source information. For example an intellectual property source may relate to a project, a particular code base, a specific database or technology as identified by the intellectual property information owner or asset manager.

An intellectual property professional may specify the topics or elements of interest as well as the degree to which an element must match the specified criteria. For example, the match may be specified as a direct match, in which all specified name and value pair information must be found as specified, an indirect match in which just the name must be found, or a fuzzy match, in which various acceptable synonyms or fragments of the specified criteria are required to be found. Elements of interest are saved as elements of interest 328 for further review, and used in queries.

In addition a statistical match may also be requested based on relevance. Relevance is determined by the number of matches for each instance of a set of possible values that is found. In this manner, a user may accept a specified percentage match, such as a 70 percent match, indicating the match is relevant and a good approximation, but not exact.

Publication service 310 provides a capability to push notifications out to subscribing users based on the findings of monitor service 314. Publication service 310 provides the outbound messaging function to make the subscribers aware of elements of interest as requested using addressing information maintained by subscription service 308.

Report builder service 312 compiles and formats information retrieved by the execution of a set of queries 322 against intellectual property source 302. Reports may be in the form of simple notification messages or more complex forms based on detailed queries in the set of queries 322. The report builder uses output of query service 306 to produce identified elements sent using notifier of identified elements 326.

Monitor service 314 provides a capability to execute query service 306 invoking the set of queries 322 as required generating information according to the requests of the subscribers. The service may schedule queries to be executed at predetermined times or intervals or triggered by specific events, such as a document update.

Search word list 316 represents a set of search criteria as determined by collecting information requests from the list of subscribers. The information collected also defines elements of interest 328 as determined by the intellectual property professionals. The search words are useful when performing free text searches of the source information in the absence of tagged or marked entries. Keyword list and synonym list 324 are also used to aid in forming the search criteria. Keywords may be used in prompts for more exact information or directly as search criteria. Synonym list elements may be used to expand the scope of search word list 316.

With reference to FIG. 4, a text representation of an example of search arguments in accordance with illustrative embodiments is shown. Example 400 provides a selection of search style examples including direct search 402, indirect search 404, and fuzzy search 406. Direct search 402 uses a fully qualified description. For example, the full attribute name and corresponding value pair is specified as the search criteria, such as the string or phrase “copyright=abc.” Boolean operations are used as well to include or exclude values. In the indirect search 404 form the value is not present, just the attribute specification to provide an “all” result capturing all cases of “copyright” occurrences.

Fuzzy search 406 provides for synonyms of values to be used as in the case of “like” or “approximation.” For example, term “SLA” 408 may be substituted by “service level agreement” 410, “service agreement” 412, or just “service” 414. In another example, the attribute name author may be found having a value of a form of the term “john” comprising a prefix or suffix. In this example, “Upjohn” and “Johnson” would be found if in the author attribute.

With reference to FIG. 5, a text representation of an example marking of code in accordance with illustrative embodiments is shown. Within example 500 there is provided an extensible markup language example 502, a comment based example 512 and a highlighted or delimited example 514. Extensible markup language example 502 provides a clearly self describing form of marking or tagging. The block of descriptors are opened and closed with appropriate start 504 and end 506 tags. Within these boundaries is located information for attribute 508 and 510 tags. In each of these tags, the keyword ‘att name’ indicates the name of the described attribute follows along with an associated value in the “value” component. For example, the string may appear as <att name=“author” value=“jones”/> to denote the assignment of the value jones to the attribute author.

In another form, comment based example 512 shows use of the start and end comment delimiter bounding a value. Value may be a string of characters of interest. For example, the author information may have been stored as a comment in the code segment as /* author=jones */. The comment would not alter processing of the code, but would serve the purpose of containing author information to serve notice to other users.

In a similar manner, example 514 depicts another delimited value. In this case, the percent sign is used to start and end the bounded characters. This may serve as an independent form of mark and is suitable for text based documents. For example, the string “% author Johnson %” may be inserted into a text document to provide an easily identifiable descriptor that would not normally occur in the document.

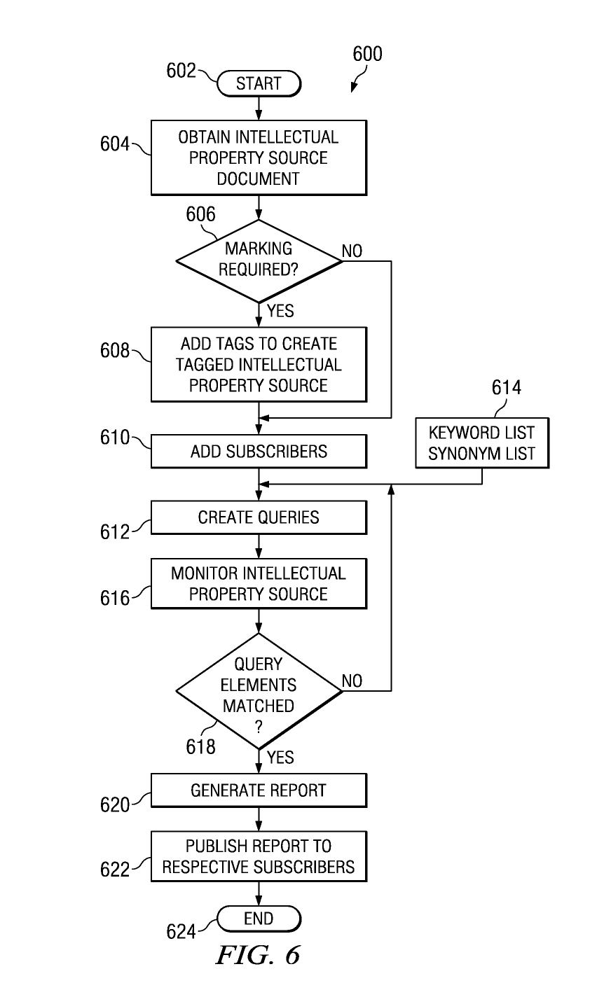

With reference to FIG. 6, a flowchart of an example subscription and publication process in accordance with illustrative embodiments is shown. The subscription and publication process is an example process as performed by subscription and publication manager 318 of FIG. 3.

Process 600 begins at start (step 602) and obtains intellectual property source documents (step 604). The intellectual property source may be a set of documents maintained in a database or other form of searchable data files. A determination is made as to whether marking is required (step 606). If marking is needed in the intellectual property source, a “yes” results and tags are added to create a tagged intellectual property source (step 608). If marking is not required a “no” results and subscriptions are created in an add subscribers operation (step 610).

Queries are created to extract information of interest from the intellectual property source documents (step 612). The queries created also use information stored in keyword lists and synonym lists (step 614). The keyword lists and synonym lists are particularly useful in conjunction with the unmarked intellectual property source. The queries represent patterns of data that are deemed to be of interest.

Monitor intellectual property source comprises executing the various queries to determine whether intellectual property elements of interest to the subscribers exist in the intellectual property source (step 616). The queries may be executed on a predetermined schedule or associated with an event, such as a document update or combination. Queries may be appropriately optimized to operate with either a marked or unmarked source.

A determination is made as to whether query criteria of interest match information contained within the intellectual property source being examined (step 618). If there is no match, process 600 returns to create queries again in step 612. The queries are then adjusted for any new criteria.

If a match is found in step 618, a “yes” results with generate reports being performed (step 620). The reports are based on the matching information found during the execution of the queries. A report may be a simple result contained in a message or a more lengthy detailed report. For example, a simple report may be a single message to notify a subscriber of a “hit” in a document. A more complex example may include a series of “hits” formatted into a multi-page document attached to a message.

Having generated the report, the report is then published to the respective subscribers (step 622) with the process terminating thereafter (step 624). Each subscriber is to receive only a report for the specified elements of interest for that subscriber. In an alternative implementation, a publication service can also be used to generate and publish an overall awareness report to all subscribers, if needed, in the form of a broadcast. A broadcast would be a capability reserved for an administrator of the subscribe and publish process.

Thus, the illustrative embodiments provide a capability for the marking or not marking of intellectual property source documentation. Such marking, if used, could be performed based on various dates or events within the product development cycle providing necessary descriptive information and a very close tie to the product. The subscribe and publish system also allows intellectual property professionals to request to subscribe to receive notification of intellectual property items of interest. The intellectual property professional, through use of the subscription and publication service, remains anonymous and undetected in their respective interest in the development of the intellectual property. However, a professional could contact an individual related to the intellectual property, initiate a non-disclosure agreement, use an intermediary to learn more, or otherwise affect the course of the development of the intellectual property based on knowledge gained through notification. The illustrative embodiments thereby provide a tool for the capture, and notification of intellectual property elements within intellectual property source documents enabling intellectual property professionals to better control and manage the intellectual property assets.

The invention can take the form of an entirely hardware embodiment, an entirely software embodiment or an embodiment containing both hardware and software elements. In a preferred embodiment, the invention is implemented in software, which includes but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable recordable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for an intellectual property subscribe and publication notification service, the computer implemented method comprising:
obtaining an intellectual property source;
creating a list of approved subscribers for the intellectual property source, wherein each subscriber in the list of approved subscribers indicates elements of interest;
creating a set of queries comprising the elements of interest associated with the list of subscribers;
monitoring the intellectual property source for the elements of interest to create identified elements of interest; and
publishing notification of the identified elements of interest to the list of approved subscribers.

2. The computer implemented method of claim 1, wherein obtaining an intellectual property source further comprises:
marking the intellectual property source to create a tagged intellectual property source.

3. The computer implemented method of claim 1, wherein creating a set of queries further comprises:
obtaining a keyword list and a synonym list; and
incorporating entries from the keyword list and the synonym list in the queries in the set of queries.

4. The computer implemented method of claim 1, wherein monitoring the intellectual property source further comprises:
executing the set of queries;
determining whether the elements of interest associated with the list of approved subscribers in the set of queries are present in the intellectual property source; and
responsive to the determination that the elements of interest are present in the intellectual property source, generating respective reports for the identified elements of interest.

5. The computer implemented method of claim 1, wherein publishing notification further comprises:
sending a report to a requesting subscriber of the list of approved subscribers, wherein the report comprises the elements of interest to the requesting subscriber.

6. A data processing system for an intellectual property subscribe and publication notification service, the data processing system comprising:
a bus;
a memory connected to the bus, the memory containing computer executable instructions therein;
a communications unit connected to the bus;
a persistent storage connected to the bus;
a processor unit connected to the bus, wherein the processor unit executes the computer executable instructions in the memory, causing the data processing system to:
obtain an intellectual property source;
create a list of approved subscribers for the intellectual property source, wherein each subscriber in the list of approved subscribers indicating elements of interest;
create a set of queries comprising the elements of interest associated with the list of subscribers;
monitor the intellectual property source for the elements of interest to create identified elements of interest; and
publish notification of the identified elements of interest to the list of approved subscribers.

7. The data processing system of claim 6, wherein causing the data processing system to obtain an intellectual property source further comprises:
marking the intellectual property source to create a tagged intellectual property source.

8. The data processing system of claim 6, wherein causing the data processing system to create a set of queries further comprises:
obtaining a keyword list and a synonym list; and
incorporating entries from the keyword list and the synonym list in the queries in the set of queries.

9. The data processing system of claim 6, wherein causing the data processing system to monitor the intellectual property source further comprises:
executing the set of queries;
determining whether the elements of interest associated with the list of approved subscribers in the set of queries are present in the intellectual property source; and
responsive to the determination that the elements of interest are present in the intellectual property source, generating respective reports for the identified elements of interest.

10. The data processing system of claim 6, wherein causing the data processing system to publish notification further comprises:
sending a report to a requesting subscriber in the list of approved subscribers, wherein the report comprises the elements of interest to the requesting subscriber.

11. A computer program product for an intellectual property subscribe and publication notification service, the computer program product comprising a computer usable recordable medium having computer executable instructions tangibly embodied thereon, the computer executable instructions comprising:
computer executable instructions for obtaining an intellectual property source;
computer executable instructions for creating a list of approved subscribers for the intellectual property source, wherein each subscriber in the list of approved subscribers indicates elements of interest;
computer executable instructions for creating a set of queries comprising the elements of interest associated with the list of subscribers;
computer executable instructions for monitoring the intellectual property source for the elements of interest to create identified elements of interest; and
computer executable instructions for publishing notification of the identified elements of interest to the list of approved subscribers.

12. The computer program product of claim 11, wherein computer executable instructions for obtaining an intellectual property source further comprises:
computer executable instructions for marking the intellectual property source to create a tagged intellectual property source.

13. The computer program product of claim 11, wherein computer executable instructions for creating a set of queries further comprises:
computer executable instructions for obtaining a keyword list and a synonym list; and
computer executable instructions for incorporating entries from the keyword list and the synonym list in the queries in the set of queries.

14. The computer program product of claim 11, wherein computer executable instructions for monitoring the intellectual property source further comprises:
computer executable instructions for executing the set of queries;
computer executable instructions for determining whether the elements of interest associated with the list of approved subscribers in the set of queries are present in the intellectual property source; and
computer executable instructions responsive to the determination that the elements of interest are present in the intellectual property source, for generating respective reports for the identified elements of interest.

15. The computer program product of claim 11, wherein computer executable instructions for publishing notification further comprises:
computer executable instructions for sending a report to a requesting subscriber of the list of approved subscribers, wherein the report comprises the elements of interest to the requesting subscriber.
